(19) United States
(12) Patent Application Publication
(10) Pub. No.: US 2025/0069383 A1
(43) Pub. Date: Feb. 27, 2025

(54) SYSTEM AND METHOD FOR CREATING TRAINING DATA FOR DEEPFAKES

(71) Applicant: Benjamin Israel Traub, Englewood, FL (US)

(72) Inventor: Benjamin Israel Traub, Englewood, FL (US)

(21) Appl. No.: 18/801,495

(22) Filed: Aug. 12, 2024

Related U.S. Application Data
(60) Provisional application No. 63/578,957, filed on Aug. 25, 2023.

(51) Int. Cl. G06V 10/82; G06T 13/40; G06V 10/774

(52) U.S. Cl. CPC G06V 10/82; G06T 13/40; G06V 10/774

(57) ABSTRACT

According to an aspect of the present invention disclosed herein, there is provided a method for creating training data for deepfakes, comprising: creating a 3D animated face CG Digital Double; generate custom training footage simulating a target individual; and feeding the custom training footage into a Deepfake Neural Network. According to another aspect of the present invention, there is provided a system for creating training data for deepfakes, comprising: one or more computer memory devices; one or more processors, wherein the one or more processors are configured for operations comprising: creating a 3D animated face CG Digital Double; generate custom training footage simulating a target individual; and feeding the custom training footage into a Deepfake Neural Network.

### BACKGROUND

The term “deepfake” comes from the combination of “deep learning” and “fake”, as it uses deep learning techniques and neural networks to create fake content, replacing the face of a person in an image or video with the face of another person.

Patent literature relating to creation of deepfakes often uses other language to describe the technology. For example, U.S. Pat. No. 11,475,608 discloses machine learning techniques to generate synthetic still images and video sequences. These synthetic still images and video sequences may be photorealistic representations of real people, places, or things, but are not real images. The operations include obtaining an input image that depicts a face of a subject, wherein the face of the subject has an initial facial expression and an initial pose, determining a reference shape description based on the input image, determining a target shape description based on the reference shape description, a facial expression difference, and a pose difference, generating a rendered target shape image using the target shape description, and generating an output image based on the input image and the rendered target shape using an image generator, wherein the output image is a simulated image of the subject of the input image that has a final expression that is based on the initial facial expression and the facial expression difference, and a final pose that is based on the initial pose and the pose difference.

Generally the prior art patent literature utilizes deepfake in a negative sense and discloses methods and systems to detect deepfakes. For example, U.S. Pat. No. 11,430,102 describes a content analyzer which determines whether various types of modification have been made to images. The content analyzer computes JPEG ghosts from the images that are concatenated with the image channels to generate a feature vector. The feature vector is provided as input to a neural network that determines whether the types of modification have been made to the image. The neural network may include a constrained convolution layer and several unconstrained convolution layers. An image fake model may also be applied to determine whether the image was generated using a computer model or algorithm.

Although potentially illegal or leading to harm in certain circumstances, methods and systems for creation of “deepfakes”, i.e., synthetic still images and video sequences which are photorealistic representations of real people, places, or things, but are not actually real images are in demand commercially and applied in an ethical matter are useful to society. Existing methods and systems for creation of deepfakes suffer from limitations including heavy computational load.

### SUMMARY OF INVENTION

Therefore, the present invention is a system and method utilizing a 3D animated face to generate custom training footage for Deepfakes. This computer-generated footage is then used to train a deepfake Neural Network, enabling the creation of convincing deepfakes for individuals who don't exist or have limited visual data available, such as photographs.

According to an aspect of the present invention disclosed herein, there is provided a method for creating training data for deepfakes, comprising: creating a 3D animated face CG Digital Double; generate custom training footage simulating a target individual; and feeding the custom training footage into a Deepfake Neural Network.

According to another aspect of the present invention, there is provided a system for creating training data for deepfakes, comprising: one or more computer memory devices; one or more processors, wherein the one or more processors are configured for operations comprising: creating a 3D animated face CG Digital Double; generate custom training footage simulating a target individual; and feeding the custom training footage into a Deepfake Neural Network.

According to yet another aspect of the present invention, there is provided a non-transitory computer readable medium comprising instructions which, when executed by at least one computer processor, cause at the least one computer processor to at least: creating a 3D animated face CG Digital Double; generate custom training footage simulating a target individual; and feeding the custom training footage into a Deepfake Neural Network.

### BRIEF DESCRIPTION OF THE DRAWINGS

FIG. 1 illustrates a process according to an embodiment of the present invention for creation of deepfakes.

### DETAILED DESCRIPTION

Deepfake technology has gained popularity in recent years for its ability to create highly realistic videos by swapping faces in existing footage. However, one of the limitations of conventional deepfake methods is the requirement for extensive real-world training data for the target individuals. There are significant challenges in creating convincing deepfakes of people who don't exist or those with limited video footage or only photographs. The present invention aims to address this limitation by providing a novel way to generate custom training data for deepfake applications.

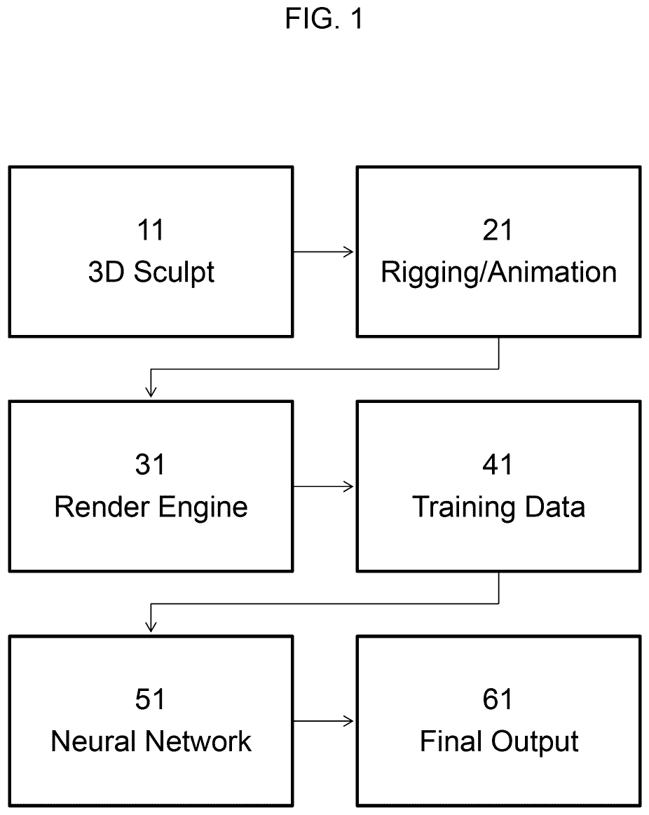

FIG. 1 illustrates a process according to an embodiment of the present invention for creation of deepfakes.

The method involves the following steps:

3D Animated Face Generation: Utilizing 3D animation technologies, we create a 3D animated face, commonly referred to as a CG Digital Double (see Reference Numeral 11 for 3D Sculpt). This Digital Double serves as a digital representation of the target individual.

Custom Training Footage Generation: Using the 3D animated face, we generate custom training footage simulating various facial expressions, head movements, and speech patterns (see Reference Numeral 21 for Rigging/Animation). The CG footage is then created (see Reference Numeral 31 for Render Engine) to be diverse and representative of the target individual's appearance and behavior.

Deepfake Neural Network Training: The generated custom training footage is then fed into a Deepfake Neural Network, specifically a Generative Adversarial Network (GAN) (see Reference Numeral 51 for Neural Network). The GAN learns from this data (see Reference Numeral 41 for Training Data) and improves its ability to generate realistic deepfakes of the target individual (see Reference Numeral 61 for Final Output).

The proposed method offers several advantages over existing deepfake techniques:

Limited Visual Data: Individuals who do not exist or those with limited video footage or only photographs can now have deepfakes created using the custom training data generated from a 3D animated face (see Reference Numeral 11 for 3D Sculpt).

Realism and Accuracy: The use of advanced 3D animation technology can ensure that the generated custom training footage captures the essence of the target individual's facial features and expressions, leading to the desired realism and accuracy in deepfakes.

The novel method for creating training data for deepfakes, as described above, provides an innovative solution for the creation of deepfakes of individuals with limited or non-existent visual data. The utilization of a 3D animated face to generate custom training footage can allow for more realistic and accurate deepfake generation as it can also be used to supplement real footage of an individual who may not have the correct performance needed to accurately match the target footage (see Reference Numeral 61 for Final Output).

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description.

Other embodiments may be utilized and derived from the present invention, such that structural and logical substitutions and changes may be made without departing from the scope of this disclosure.

Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method for creating training data for deepfakes, comprising:
creating a 3D animated face CG Digital Double;
generate custom training footage simulating a target individual; and
feeding the custom training footage into a Deepfake Neural Network.

2. The method for creating training data for deepfakes of claim 1, wherein the Deepfake Neural Network is a Generative Adversarial Network (GAN).

3. The method for creating training data for deepfakes of claim 2, wherein the GAN learns from this data and improves its ability to generate realistic deepfakes of the target individual.

4. The method for creating training data for deepfakes of claim 1, wherein the custom training footage simulates facial expressions.

5. The method for creating training data for deepfakes of claim 1, wherein the custom training footage simulates head movements.

6. The method for creating training data for deepfakes of claim 1, wherein the custom training footage simulates speech patterns.

7. A system for creating training data for deepfakes, comprising:
one or more computer memory devices; and
one or more processors,
wherein the one or more processors are configured for operations comprising at least:
creating a 3D animated face CG Digital Double;
generate custom training footage simulating a target individual; and
feeding the custom training footage into a Deepfake Neural Network.

8. A non-transitory computer readable medium comprising instructions which, when executed by at least one computer processor, cause at the least one computer processor to at least:
creating a 3D animated face CG Digital Double;
generate custom training footage simulating a target individual; and
feeding the custom training footage into a Deepfake Neural Network.
